(19) United States
(12) Patent Application Publication
(10) Pub. No.: US 2023/0306372 A1
(43) Pub. Date: Sep. 28, 2023

(54) DEEP NEURAL NETWORK FOR INGESTED JOB LISTINGS

(71) Applicant: Microsoft Technology Licensing, LLC, Redmond, WA (US)

(72) Inventors: Xilun Chen, Sunnyvale, CA (US); Chen-Kun Chuang, Sunnyvale, CA (US); Xing Wu, Santa Clara, CA (US); Fei Chen, Saratoga, CA (US); Wenxuan Gao, Santa Clara, CA (US); Jingwei Wu, Foster City, CA (US); Rohan Rajiv, Danville, CA (US); Swathi Singh, Cumming, GA (US); Mathias Arkayin, San Francisco, CA (US); Andrew Wu, Berkeley, CA (US)

(21) Appl. No.: 17/688,409

(22) Filed: Mar. 7, 2022

(51) Int. Cl. G06Q 10/10; G06N 3/08

(52) U.S. Cl. CPC G06Q 10/1053; G06N 3/08

(57) ABSTRACT

In an example embodiment, a deep neural network is used to predict a classification for ingested job listings for a piece of information that is missing from the ingested job listings. More particularly, the deep neural network may comprise a multi-layer perceptron with a plurality of rectifier linear units (ReLUs). For a given category of information, a plurality of different information entities may be evaluated by the multi-layer perceptron against features of a job listing, producing a probability prediction of reach of those information entities for the job listing. The information entity with the highest predicted probability is identified by the multi-layer perceptron as the predicted information entity for that given category of information for the job listing.

### TECHNICAL FIELD

The present disclosure generally relates to technical problems encountered in machine learning. More specifically, the present disclosure relates to the use of deep learning for ingested job listings.

### BACKGROUND

The rise of the Internet has occasioned two disparate yet related phenomena: the increase in the presence of online networks, such as social networking services, with their corresponding user profiles visible to large numbers of people, and the increase in the use of these online networking services to provide content. An example of such content is job listing content. Here, job listings are posted to a social networking service, and these job listings are presented to users of the social networking service, either as results of job searches performed by the users in the social networking service, or as unsolicited content presented to users in various other channels of the social networking service.

Job-related content can also be presented in online networking services in other ways. For example, users may list their current jobs in their user profiles, including an indication of the entity they work for and their job title. Other users may view these user profiles and see this information. Additionally, as a user updates their user profile (such as to reflect a promotion) or performs other social networking updates (such as indicating they were mentioned in a news article), their job title may additionally be shared with other users at this point.

In some social networking services, job listings can be either input directly into the social networking service, such as by using a user interface created by the social networking service to populate fields of a job listing, or may be ingested into the social networking service from outside data sources, either expressly under the direction of the job poster, or by automatically ingesting entire databases of job listings on a periodic basis without explicit user action.

When a job listed is input into the social networking service directly, the social networking service has much more control over the information the job poster provides. This is because the user interface can be designed to explicitly ask for certain types of information, and can even be designed to require that information before the job listing will be posted. Such control is not available for ingested job listings. This can lead to a gap in information between directly-inputted job listings and ingested job listings, especially for types of information which the social networking service may deem important but that are not traditionally provided in job listings. This can also include information that only has become more important recently, such as whether a job listing is for a job that is in-person or remote (or a hybrid of the two). Traditionally remote jobs were rare and specialized. With the Covid crises, however, remote jobs are no longer rare or specialized, and indeed just about any job type has the possibility of being a remote job. Despite this, many job posters will not explicitly provide information about whether the underlying job is remote or in-person (or hybrid), typically because the concept of having certain jobs be remote is so new it hasn’t yet become standard to provide that information in every job listing.

Traditionally the gap in information between directly-input job listings and ingested job listings was filled through the use of various computer-implemented models that inferred such information in ingested job listings by searching for the presence and frequency of certain keywords in a job listing. For example, such computer models may be regular expression models that may look for the presence of the term “remote” or its synonyms and infer the job is remote if the term(s) are present and are present frequently enough. This approach has technical limitations, however, as it is imprecise and also does not allow for different degrees of “remoteness” or the evaluation of those degrees to categorize the job listing in a way that is meaningful enough for job seekers to search and filter job listings based on the output of the models.

What is needed is a solution that can provide more accurate and granular predictions about remoteness of jobs in job listings than prior art models.

### BRIEF DESCRIPTION OF THE DRAWINGS

Some embodiments of the technology are illustrated, by way of example and not limitation, in the figures of the accompanying drawings.

FIG. 1 is a block diagram showing the functional components of a social networking service, including a data processing module referred to herein as a search engine, for use in generating and providing search results for a search query, consistent with some embodiments of the present disclosure.

FIG. 2 is a block diagram illustrating the application server module of FIG. 1 in more detail, in accordance with an example embodiment.

FIG. 3 is a flow diagram illustrating a method of training a neural network, in accordance with an example embodiment.

FIG. 4 is a flow diagram illustrating a method of using a trained neural network, in accordance with an example embodiment.

FIG. 5 is a block diagram illustrating a software architecture, in accordance with an example embodiment.

FIG. 6 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, a deep neural network is used to predict a classification for ingested job listings for a piece of information that is missing from the ingested job listings. More particularly, the deep neural network may comprise a multi-layer perceptron with a plurality of rectifier linear units (ReLUs). For a given category of information, a plurality of different information entities may be evaluated by the multi-layer perceptron against features of a job listing, producing a probability prediction of reach of those information entities for the job listing. The information entity with the highest predicted probability is identified by the multi-layer perceptron as the predicted information entity for that given category of information for the job listing.

In an example embodiment, the category of information is workplace type and the plurality of different information entities include the different possible values for the workplace type variable: namely “onsite”, “remote”, and “hybrid”. The deep neural network may therefore be used to predict, for an ingested job listing, whether the job corresponding to the ingested job listing is onsite, remote, or hybrid. This information may then be used by the social networking service in a variety of different ways, including allowing job seekers to search or filter job listings based on selections of one or more of these categories as a criterion, as well as automatically serving job listings matching the preferences of the user.

Training of the deep neural network may be accomplished using directly-inputted job listings, i.e., job listings that were directly submitted to the social networking service via a user interface provided by the social networking service, in contrast to job listings that were ingested from another source. This allows the training set to include job listings that are known to have user-inputted values for the information category of interest, due to the fact that the user interface can be designed to require such directly-inputted job listings to include a value for the information category of interest. Thus, for example, the social networking service’s user interface for directly inputting a job listing may require a user to input whether the corresponding job is “onsite”, “remote”, or “hybrid”. These values may then be used as labels for the training data, which would include the other portions of the job listings.

In a further example embodiment, the deep learning neural network may also include one or more additional machine-learned model components, such as an embedding layer, which may be separately trained to handle a specific type of information from the job listings input to the deep learning neural network (either during a prediction phase of the deep learning neural network or during a training phase of the deep learning neural network). The embedding layer may produce, for example, an embedding for information in a textual portion of the job listing, such as a job description. Additional input layers (such as one-hot encoding layers) may perform other types of transformation of textual or other non-numerical data into numerical data. The result is that the multi-layer perceptron may be fed only numerical input, in the form of feature vectors, which can then be concatenated for processing (either during training of the multi-layer perceptron or at prediction-time).

The result is a machine-learned model that is more accurate at predicting the values for missing information for particular informational categories of interest than prior art models.

### Description

The disclosed embodiments provide a method, apparatus, and system for training and using a deep learning machine-learned model that predicts a classification for ingested job listings for a piece of information that is missing from the ingested job listings. More particularly, the deep neural network may comprise a multi-layer perceptron with a plurality of rectifier linear units (ReLUs). For a given category of information, a plurality of different information entities may be evaluated by the multi-layer perceptron against features of a job listing, producing a probability prediction of reach of those information entities for the job listing. The information entity with the highest predicted probability is identified by the multi-layer perceptron as the predicted information entity for that given category of information for the job listing.

It should be noted that while specific embodiments are described herein in the context of workplace types (e.g., on-site, remote, or hybrid, with hybrid being a mixture of on-site and remote), the same deep learning model may be used to predict other types of informational categories of interest, and nothing in this document shall be interpreted as limiting scope of protection to predicting only workplace types or only those specific workplace types described herein.

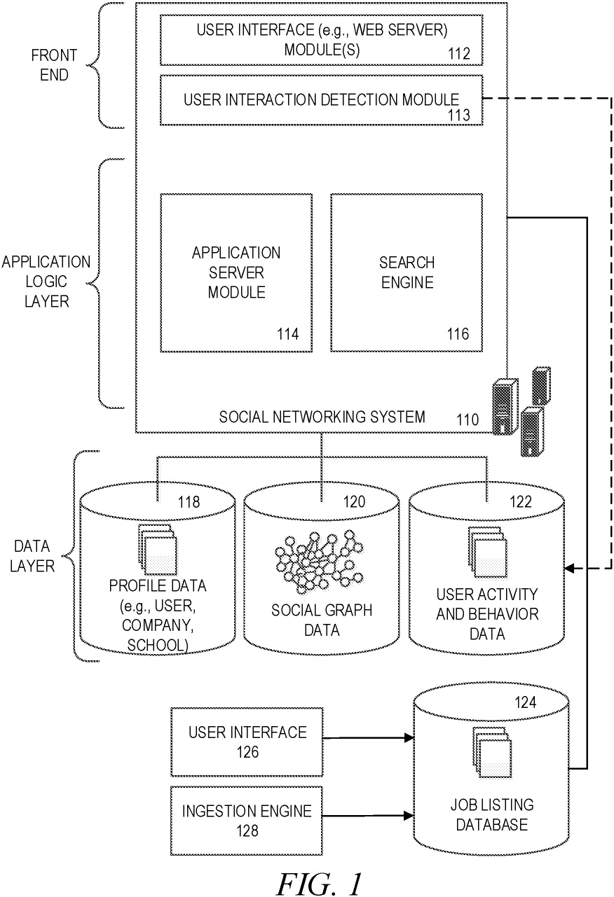

FIG. 1 is a block diagram showing the functional components of a social networking service, including a data processing module referred to herein as a search engine, for use in generating and providing search results for a search query, consistent with some embodiments of the present disclosure.

As shown in FIG. 1, a front end may comprise a user interface module 112, which receives requests from various client computing devices and communicates appropriate responses to the requesting client devices. For example, the user interface module(s) 112 may receive requests in the form of Hypertext Transfer Protocol (HTTP) requests or other web-based API requests. In addition, a user interaction detection module 113 may be provided to detect various interactions that users have with different applications, services, and content presented. As shown in FIG. 1, upon detecting a particular interaction, the user interaction detection module 113 logs the interaction, including the type of interaction and any metadata relating to the interaction, in a user activity and behavior database 122.

An application logic layer may include one or more various application server modules 114, which, in conjunction with the user interface module(s) 112, generate various user interfaces (e.g., web pages) with data retrieved from various data sources in a data layer. In some embodiments, individual application server modules 114 are used to implement the functionality associated with various applications and/or services provided by the social networking service.

As shown in FIG. 1, the data layer may include several databases, such as a profile database 118 for storing profile data, including both user profile data and profile data for various organizations (e.g., companies, schools, etc.). Consistent with some embodiments, when a person initially registers to become a user of the social networking service, the person will be prompted to provide some personal information, such as his or her name, age (e.g., birthdate), gender, interests, contact information, home town, address, spouse’s and/or family members’ names, educational background (e.g., schools, majors, matriculation and/or graduation dates, etc.), employment history, skills, professional organizations, and so on. This information is stored, for example, in the profile database 118. Similarly, when a representative of an organization initially registers the organization with the social networking service, the representative may be prompted to provide certain information about the organization. This information may be stored, for example, in the profile database 118, or another database (not shown). In some embodiments, the profile data may be processed (e.g., in the background or offline) to generate various derived profile data. For example, if a user has provided information about various job titles that the user has held with the same organization or different organizations, and for how long, this information can be used to infer or derive a user profile attribute indicating the user’s overall seniority level or seniority level within a particular organization. In some embodiments, importing or otherwise accessing data from one or more externally hosted data sources may enrich profile data for both users and organizations. For instance, with organizations in particular, financial data may be imported from one or more external data sources and made part of an organization’s profile. This importation of organization data and enrichment of the data will be described in more detail later in this document.

Once registered, a user may invite other users, or be invited by other users, to connect via the social networking service. A “connection” may constitute a bilateral agreement by the users, such that both users acknowledge the establishment of the connection. Similarly, in some embodiments, a user may elect to “follow” another user. In contrast to establishing a connection, the concept of “following” another user typically is a unilateral operation and, at least in some embodiments, does not require acknowledgement or approval by the user that is being followed. When one user follows another, the user who is following may receive status updates (e.g., in an activity or content stream) or other messages published by the user being followed, relating to various activities undertaken by the user being followed. Similarly, when a user follows an organization, the user becomes eligible to receive messages or status updates published on behalf of the organization. For instance, messages or status updates published on behalf of an organization that a user is following will appear in the user’s personalized data feed, commonly referred to as an activity stream or content stream. In any case, the various associations and relationships that the users establish with other users, or with other entities and objects, are stored and maintained within a social graph in a social graph database 120.

As users interact with the various applications, services, and content made available via the social networking service, the users’ interactions and behavior (e.g., content viewed, links or buttons selected, messages responded to, etc.) may be tracked, and information concerning the users’ activities and behavior may be logged or stored, for example, as indicated in FIG. 1, by the user activity and behavior database 122. This logged activity information may then be used by the search engine 116 to determine search results for a search query.

Although not shown, in some embodiments, the social networking system 110 provides an API module via which applications and services can access various data and services provided or maintained by the social networking service. For example, using an API, an application may be able to request and/or receive one or more recommendations. Such applications may be browser-based applications or may be operating system-specific. In particular, some applications may reside and execute (at least partially) on one or more mobile devices (e.g., phone or tablet computing devices) with a mobile operating system. Furthermore, while in many cases the applications or services that leverage the API may be applications and services that are developed and maintained by the entity operating the social networking service, nothing other than data privacy concerns prevents the API from being provided to the public or to certain third parties under special arrangements, thereby making the navigation recommendations available to third-party applications and services.

Although the search engine 116 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when user profiles are indexed, forward search indexes are created and stored. The search engine 116 facilitates the indexing and searching for content within the social networking service, such as the indexing and searching for data or information contained in the data layer, such as profile data (stored, e.g., in the profile database 118), social graph data (stored, e.g., in the social graph database 120), and user activity and behavior data (stored, e.g., in the user activity and behavior database 122). The search engine 116 may collect, parse, and/or store data in an index or other similar structure to facilitate the identification and retrieval of information in response to received queries for information. This may include, but is not limited to, forward search indexes, inverted indexes, N-gram indexes, and so on.

As described above, example embodiments may be utilized for ranking and/or selection of job listings. These job listings may be posted by job posters (entities that perform the posting, such as businesses) and stored in job listing database 124. Notably, the job listings stored in the job listing database 124 may come from two types of data sources. The first is from direct input via a user interface 126. The second is via ingestion from a third-party data source, using an ingestion engine 128. The ingestion engine 128 obtains job listings from one or more third-party data sources either in response to direct action from a user (e.g., a user indicating that a job listing that they posted on a third-party data source be ingested) or not in response to direct action from a user, such as a periodic polling of the one or more third-party data sources for newly-posted job listings.

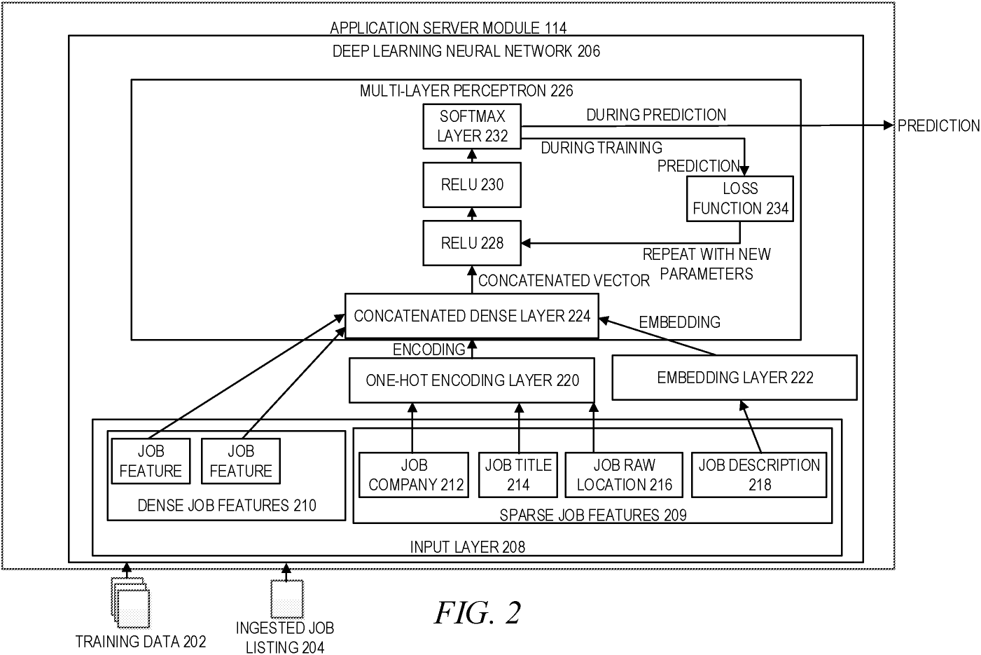

FIG. 2 is a block diagram illustrating the application server module 114 of FIG. 1 in more detail, in accordance with an example embodiment. While in many embodiments the application server module 114 will contain many subcomponents used to perform various different actions within the social networking system 110, in FIG. 2 only those components that are relevant to the present disclosure are depicted.

Here the application server module 114 performs training of a machine-learned model to predict a categorization (i.e., a value for a particular informational category) for an ingested job listing, in accordance with an example embodiment, using training data obtained from directly input job listings. The application server module 114 takes as input training data 202 (during training) or an ingested job listing (during prediction) 204. In an example embodiment, the training data 202 includes the directly input job listings, which each include a value for the particular informational category as well as other job listing information, such as job title, location, and job description. The values for the particular informational category are used as labels for the training data 202, and the ingested job listing 204 (with the labels) is fed as input to a deep learning neural network 206 during a training phase of the deep learning neural network 206.

The deep learning neural network 206 includes an input layer 208, which inputs and/or calculates various job features of any job listings fed to the deep learning neural network 206 (whether it be the directly input job listings used as training data during the training phase, or ingested job listings being categorization during a prediction phase). These features may include sparse job features 209 or dense job features 210. Sparse job features 209 are features that tend to lack relative ordering, such as text and categorical information. For job listings, common sparse job features 209 include job company 212, job title 214, job raw location 216, and job description 218. These sparse job features 209 features may be converted into vector format, with numbers in each position of each vector. This may be performed in different ways depending upon the type of sparse job feature 209 involved.

It should be noted that the term “vector” in this context shall be interpreted using the definition of how the term is used in computer software contexts, namely that it is a 1-dimensional array of values, rather than how the term is used in mathematical contexts, namely a line with a direction.

A one-hot encoding layer 220 may process categorical sparse job features 209 by creating a new binary feature for each possible categorization value and assigning a value of 1 to the feature of the job listing that corresponds to the categorization. This may be viewed as a vector with each position in the vector indicating the presence of a particular categorization value for the category. Thus, for example, in the case of job company 212, job title 214, and job raw location 216, each vector output by the one-hot encoding layer 220 may represent a different job listing, with each position in the vector representing an indication as to whether a particular job company, job title, or job raw location is present in the corresponding job listing. Thus, for example, if there are 10,000 different possible job companies, 30,000 different possible job titles, and 8,000 different possible job raw locations, then each vector may have 48,000 positions, and binary numbers for each of those 48,000 positions being either “1” (indicating the corresponding job listing included that corresponding value of job company, title, or raw location) or “0” (indicating the corresponding job listing did not include that corresponding value of job company, title, or raw location). Thus, in the case where a job listing has only a single job company, single job title, and single job raw location, only 3 of the positions in the vector corresponding to that job listing would have a “1” while the remaining 47,997 would have a “0.” It should be noted, however, that it is possible for job listings to have more than value of each category. For example, a single job may have more than one title (e.g., “vice president of human resources” and “outreach lead”), or more than one location (e.g., time is split between Los Angeles and Orange County locations), but even in such cases, the vast majority of the positions in the vector would be “0.”

An embedding layer 222 may be separately trained to predict multilingual text embeddings for the purely text-based job description 218, by learning such embeddings. Learning embeddings is a process whereby each job description is assigned a different set of coordinates in an n-dimensional space. Each of these sets of coordinates is considered a different embedding. The relationships between the sets of coordinates in the n-dimensional space is representative of the similarity of respective job descriptions - if two job descriptions are embedded to coordinates that are closer to each other in the n-dimensional space, this is indicative that the job descriptions are similar to each other, whereas job descriptions embedded to coordinates that are further from each other in the n-dimensional space is indicative that the job descriptions are dissimilar to each other. Similarity is based on the labels of the training data used to train the embedding layer 222. More particularly, in an example embodiment the embedding layer 222 may be thought of as its own machine-learned model, which is trained using training data comprising pairs of job descriptions with labels indicative of the similarity of the corresponding pairs of job descriptions. For example, the label may be a value between 0 and 1, with 0 indicating that the job descriptions in the pair are completely dissimilar and 1 indicating that the job descriptions in the pair are identical. The embedding layer 222 then learns the similarities between various job descriptions based on this training data of the embedding layer 222, and uses it to embed unlabeled job descriptions 218 fed to it from the input layer 208.

The embedding layer 222 may include a multilingual pre-trained universal text encoder to convert long raw text into a 512-dimensional dense vector, since the job description can exist in many different languages and each language may have its own way of describing workplace preferences.

Optionally, the input layer 208 may retrieve or calculate dense job features 210, such as how many words there are in the job description, how many people viewed the job listing, etc. These are job features with relative ordering, such as numerical-based features where the value has a relative meaning against other different numerical values (e.g., in the case of words in the job description, a higher value indicates more words and a lower value indicates fewer words).

Output from the one-hot encoding layer 220 and embedding layer 222, as well as the dense job features 210 (if applicable), may be fed to a concatenated dense layer 224 of a multi-layer perceptron 226. The concatenated dense layer 224 then concatenates these inputs into a single vector for each job listing. Notably, this process is made more efficient due to the fact that all of the inputs to the concatenated dense layer 224 are numerical in nature (and are either already in vector format, such as the outputs from the one-hot encoding layer 220 and embedding layer 222, or can be easily placed into vectors by virtue of being single-value numbers, such as the dense job features 210).

If this is performed during a training phase of the multi-layer perceptron 226, the concatenated vectors will include the corresponding labels from the training data 202. If this is performed during the prediction phase of the multi-layer perceptron 226, then the concatenated vectors will not include labels and the multi-layer perceptron 226 attempts to predict a value for the categorical information for each concatenated vector.

The concatenated vectors are then passed through a plurality of ReLUs 228, 230. A ReLU is a type of activation function that is linear for all positive values and zero for all negative values. An activation function helps a machine-learned model account for interaction effects (one variable affecting a prediction differently depending upon the value for another value) as well as account for non-linear effects. It should be noted that while FIG. 2 depicts two ReLUs 228, 230 in the multi-layer perceptron 226, other numbers of ReLUs are possible and nothing in this document shall be interpreted as limiting the number to exactly two.

The output of the ReLUs 228, 230 is a dense vector having dimensionality of the cardinality of the informational category (e.g., workplace type) taxonomy. Finally, this dense vector is passed through a softmax layer 232 to output a prediction for each value of the informational category. Thus, for example, for workplace type where there are three possible values for the category (onsite, remote, and hybrid), the softmax layer 232 outputs a different score for each of onsite, remote, and hybrid, and the one with the highest score represents the prediction of the value for that category for the job listing being evaluated.

While this outputted prediction can simply then be used by the social networking service for various features when it was output during prediction-time, if it is output during training of the multi-layer perceptron 226, then a loss function 234 may be evaluated. The loss function 234 evaluates function based on the outputted prediction and the label for the corresponding piece of training data, essentially determining whether the multi-layer perceptron 226 was accurate enough in its prediction. If the loss function is not minimized, then the training repeats the passing of the dense vector through the ReLUs 228, 230 and softmax layer 232, altering parameters of the ReLUs 228, 230. Thus the ReLUs 228, 230 are repetitively iterated through for each dense vector until the loss function 234 is minimized, at which point those parameters are said to have been learned. Each successive dense vector received during training also has a corresponding label that can be used for such iterative learning. The result is that the ReLUs 228, 230 are trained to optimize the parameters for the entirety of the training data 202, and these optimized parameters are then what may be used at prediction time to predict values for job listings that lack such labels.

Thus, the ReLUs 228, 230 are retrained with each piece of training data 202 fed to the deep learning neural network 206 during training, and it is also possible for a “trained” deep learning neural network 206 to be retrained at a later point by feeding additional training data into it during a subsequent training phase. Furthermore, feedback may be received regarding accuracy of predictions made during the prediction phase, and this feedback may be used to further retrain the ReLUs 228, 230.

Examples of such feedback include explicit prediction feedback (e.g., a survey provided to a job seeker indicating “we predicted that this job was fully remote even though its description did not state that explicitly, were we correct?”) or implicit prediction feedback (e.g., a large percentage of users seeking remote employment elected not to take a particular job that was inferred by the system to be remote).

Additionally, sometimes latent features such as embeddings will suffer from lack of training data or lower quality training data. In an example embodiment, in order to boost precision, additional features are included that are more explicit rather than implied, such as the presence or absence of certain keywords/key phrases in the job titles and job descriptions. Examples of such key words/phrases include “remote,” “home office,” “work at home,” “work from home,” “home workers,” “homebased,” and “home based.”

The predicted value for the informational category may then be used by the social networking service in a variety of ways. In an example embodiment, the predicted value is inserted into the ingested job listing for which it was predicted, so that the predicted value may be used in the same way that any other information in the ingested job listing may be used, such as a parameter used for searching, filtering, or determining closeness of a match of a job listing with an explicit or implicit job listing query.

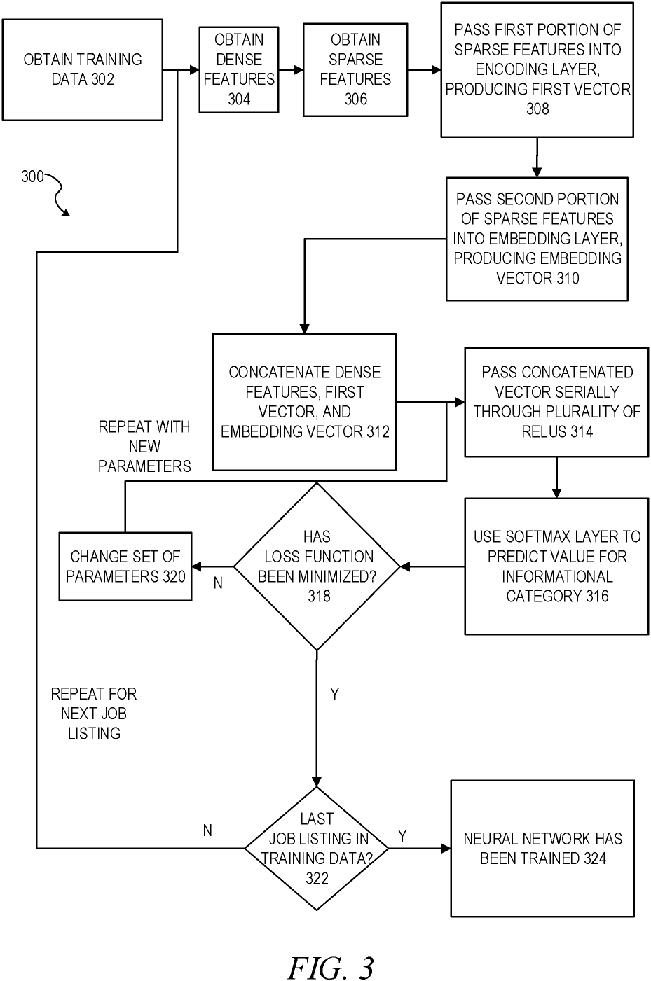

FIG. 3 is a flow diagram illustrating a method 300 of training a neural network, in accordance with an example embodiment. At operation 302, a training set of one or more job listings is obtained. This training set includes job listings that each have a value of an informational category, such as a workplace type. In an example embodiment, the training set includes one or more job listings directly input into an online network via a user interface.

A loop is then begun for each of the one or more job listings in the training set. Optionally, at operation 304, one or more dense job features may be obtained from the corresponding job listing. These dense features may include features whose value is calculated to reflect an ordering, such as number of words in the job listing or number of users who have viewed the job listing. At operation 306, a plurality of sparse features are obtained from the corresponding job listing. Obtaining in this contexts means either directly retrieving (i.e., if the feature is contained in the corresponding job listing itself) or calculating based on values in the corresponding job listing (such as a formula including variables that are determined from values in the corresponding job listing). Optionally, the plurality of sparse features may also be preprocessed, such as by transforming the sparse features into a particular format.

At operation 308, a first portion of the plurality of sparse features is passed into an encoding layer of a neural network to convert the first portion of the plurality of sparse features into a first vector. The first portion of the plurality of sparse feature may include some, but not all, of the features in the plurality of sparse features. In an example embodiment, this includes job company, job title, and job raw location. The encoding layer may be a one-hot encoding layer.

At operation 310, a second portion of the plurality of sparse features may be passed into an embedding layer of the neural network to embed the second portion of the plurality of sparse features into an embedding vector. The second portion of the plurality of sparse features may include some, but not all, of the features in the plurality of sparse features. In an example embodiment, this includes a job description.

At operation 312, the one or more dense job features (if applicable), the first vector, and the embedding vector are concatenated into a concatenated vector, in a concatenated dense layer of the neural network.

At operation 314, the concatenated vector is passed serially through a plurality of rectifier linear units (ReLUs), each ReLU using a set of parameters to apply a function to an input of the ReLU. At operation 316, a softmax layer is used to predict a value for the informational category for the corresponding job listing, based on output of the plurality of ReLUs. More particularly, since the ReLUs are used serially, the output of each ReLU is passed to the next ReLU, and the output of the last ReLU is passed to the softmax layer.

At operation 318, it is determined if a loss function, applied to the predicted value and to the value for the informational category, has been minimized. If not, then at operation 320 values for the set of parameters are changed and the method 300 loops back to operation 314. If so, then at operation 322 it is determined if this is the last job listing in the plurality of job listings that were obtained in operation 302. If not, then the method 300 loops back to operation 304 for the next job listing in the plurality of job listings. If so, however, then at operation 324 the neural network has been trained.

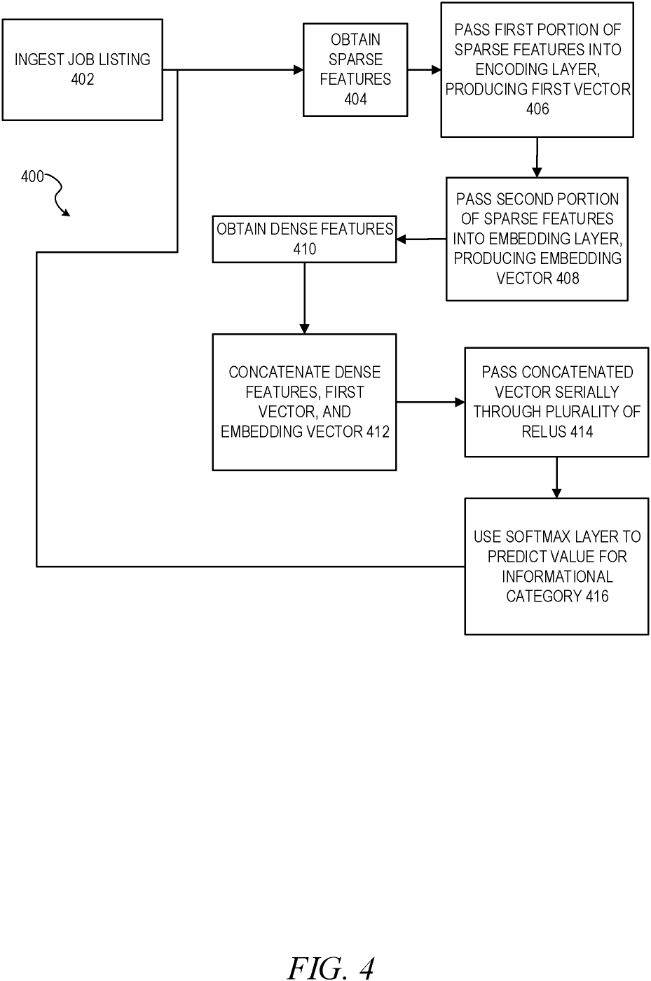

FIG. 4 is a flow diagram illustrating a method 400 of using a trained neural network, in accordance with an example embodiment. At operation 402, an ingested job listing is obtained. This ingested job listing lacks a value of an informational category, such as a workplace type. In an example embodiment, the ingested job listing is obtained from a third-party data source, and thus was not directly input into the online network via the user interface.

Optionally, at operation 403, one or more dense job features may be obtained from the ingested job listing. At operation 404, a plurality of sparse features are obtained from the ingested job listing.

At operation 406, a first portion of the plurality of sparse features is passed into the encoding layer of the neural network to convert the first portion of the plurality of sparse features into a first vector for the ingested job listing.

At operation 408, a second portion of the plurality of sparse features may be passed into the embedding layer of the neural network to embed the second portion of the plurality of sparse features into an embedding vector for the ingested job listing.

At operation 412, the one or more dense job features (if applicable), the first vector, and the embedding vector for the ingested job listing are concatenated into a concatenated vector for the ingested job listing, in a concatenated dense layer of the neural network.

At operation 414, the concatenated vector is passed serially through a plurality of rectifier linear units (ReLUs), each ReLU using a set of parameters to apply a function to an input of the ReLU. At operation 416, a softmax layer is used to predict a value for the informational category for the ingested job listing, based on output of the plurality of ReLUs. More particularly, since the ReLUs are used serially, the output of each ReLU is passed to the next ReLU, and the output of the last ReLU is passed to the softmax layer.

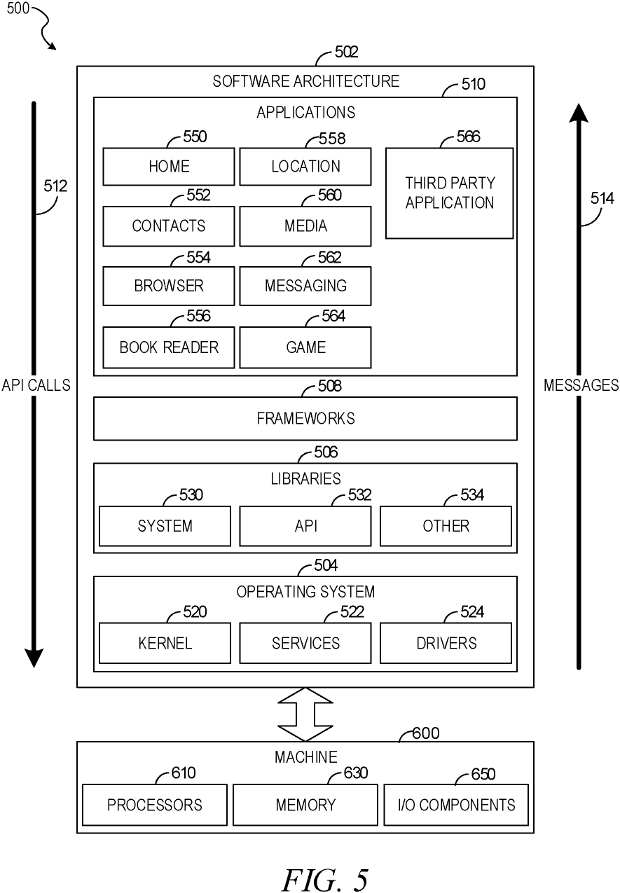

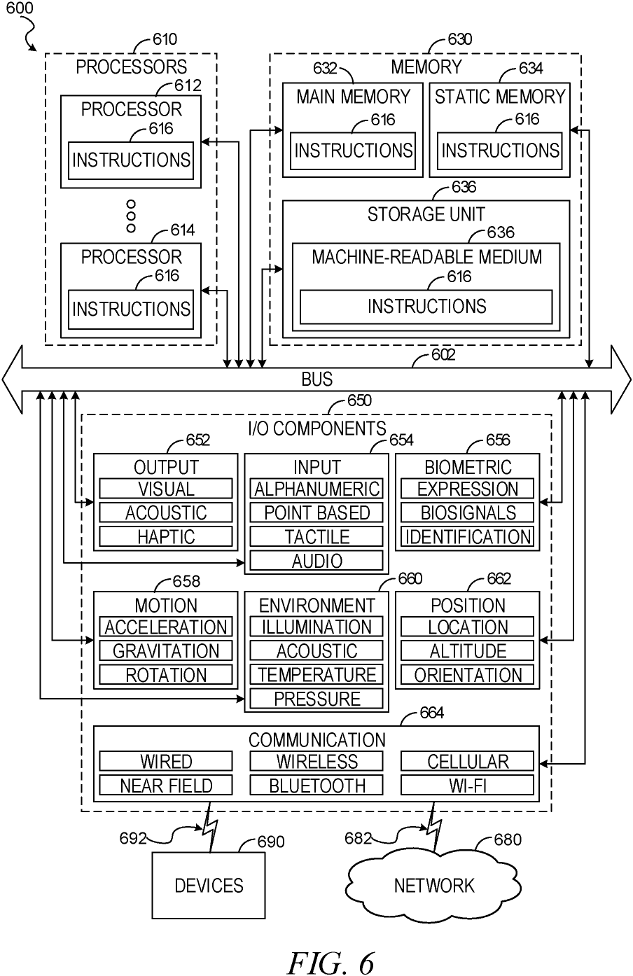

FIG. 5 is a block diagram 500 illustrating a software architecture 502, which can be installed on any one or more of the devices described above. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke API calls 512 through the software stack and receive messages 514 in response to the API calls 512, consistent with some embodiments.

In various implementations, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510, according to some embodiments. For example, the frameworks 508 provide various graphical user interface functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine 600 to perform any one or more of the methodologies discussed herein, according to an example embodiment. Specifically, FIG. 6 shows a diagrammatic representation of the machine 600 in the example form of a computer system, within which instructions 616 (e.g., software, a program, an application 510, an applet, an app, or other executable code) for causing the machine 600 to perform any one or more of the methodologies discussed herein may be executed. For example, the instructions 616 may cause the machine 600 to execute the methods 300, 400 of FIGS. 3 and 4. Additionally, or alternatively, the instructions 616 may implement FIGS. 1-4, and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 612 and a processor 614 that may execute the instructions 616. The term “processor” is intended to include multi-core processors 610 that may comprise two or more independent processors 612 (sometimes referred to as “cores”) that may execute instructions 616 contemporaneously. Although FIG. 6 shows multiple processors 610, the machine 600 may include a single processor 612 with a single core, a single processor 612 with multiple cores (e.g., a multi-core processor), multiple processors 610 with a single core, multiple processors 610 with multiple cores, or any combination thereof.

The memory 630 may include a main memory 632, a static memory 634, and a storage unit 636, all accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor’s cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine 600 will depend on the type of machine 600. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion, and the grouping is in no way limiting. In various example embodiments, the I/O components 650 may include output components 652 and input components 654. The output components 652 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 690 via a coupling 682 and a coupling 692, respectively. For example, the communication components 664 may include a network interface component or another suitable device to interface with the network 680. In further examples, the communication components 664 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 690 may be another machine or any of a wide variety of peripheral devices (e.g., a peripheral device coupled via a USB).

Moreover, the communication components 664 may detect identifiers or include components operable to detect identifiers. For example, the communication components 664 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 630, 632, 634, and/or memory of the processor(s) 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 616 and/or data. The terms shall accordingly be taken to include, but not be limited to, solid-state memories, and optical and magnetic media, including memory internal or external to the processors 610. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magnetooptical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 680 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 616 may be transmitted or received over the network 680 using a transmission medium via a network interface device (e.g., a network interface component included in the communication components 664) and utilizing any one of a number of well-known transfer protocols (e.g., HTTP). Similarly, the instructions 616 may be transmitted or received using a transmission medium via the coupling 692 (e.g., a peer-to-peer coupling) to the devices 690. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
a non-transitory computer-readable medium having instructions stored thereon, which, when executed by a processor, cause the system to perform operations comprising:
obtaining a training set of one or more job listings having a value of an informational category, the one or more job listings directly input into an online network via a user interface;
for each of the one or more job listings in the training set:
obtaining a plurality of sparse features from the corresponding job listing;
passing a first portion of the plurality of sparse features into an encoding layer of a neural network to convert the first portion of the plurality of sparse features into a first vector;
passing a second portion of the plurality of sparse features into an embedding layer of the neural network to embed the second portion of the plurality of sparse features into an embedding vector;
concatenating the first vector and the embedding vector into a concatenated vector, in a concatenated dense layer of the neural network;
passing the concatenated vector serially through a plurality of rectifier linear units (ReLUs), each ReLU using a set of parameters to apply a function to the input of the ReLU; and
using a softmax layer to predict a value for the informational category for the corresponding job listing, based on output of the plurality of ReLUs.

2. The system of claim 1, wherein the operations further comprise, for each of the one or more job listings in the training set:
determining if a loss function applied to the predicted value and to the value for the informational category has been minimized; and
in response to a determination that the loss function has not been minimized, changing values for the set of parameters and repeating the obtaining a plurality of sparse features, passing a first portion, passing a second portion, concatenating the first vector and the embedding vector to a concatenated vector, passing the concatenated vector, and using a softmax layer.

3. The system of claim 1, wherein the embedding vector is a coordinate in an n-dimensional space.

4. The system of claim 1, wherein the first portion of the plurality of sparse features comprises one or more of job company, job title, and job location.

5. The system of claim 1, wherein the second portion of the plurality of sparse features includes job description.

6. The system of claim 1, wherein the operations further comprise:
for each of the one or more job listings in the training set:
obtaining one or more dense features from the corresponding job listing;
wherein the concatenating further comprises concatenating the one or more dense features, the first vector, and the embedding vector into a concatenated vector.

7. The system of claim 1, wherein the informational category is workplace type.

8. The system of claim 7, wherein possible values for the workplace type include on-site, remote, and hybrid.

9. The system of claim 1, wherein the encoding layer is a one-hot encoding layer.

10. The system of claim 1, wherein the operations further comprise: training the embedding layer by passing pairs of job listings in a second training set of job listings, each pair including a label indicative of similarity of the second portion of the plurality of sparse features between each job listing in the pair, into a machine-learning algorithm.

11. The system of claim 1, wherein the operations further comprise:
obtaining an ingested job listing by retrieving the ingested job listing from a third-party data source, the ingested job listing lacking a value of the informational category; and
predicting a value of the informastional category for the ingested job listing using the neural network.

12. The system of claim 11, wherein the predicting a value includes:
obtaining a plurality of sparse features from the ingested job listing;
passing a first portion of the plurality of sparse features into the encoding layer of the neural network to convert the first portion of the plurality of sparse features into a first vector for the ingested job listing;
passing a second portion of the plurality of sparse features into the embedding layer of the neural network to embed the second portion of the plurality of sparse features into an embedding vector for the ingested job listing;
concatenating the first vector and the embedding vector into a concatenated vector for the ingested job listing, in the concatenated dense layer of the neural network;
passing the concatenated vector serially through the plurality of rectifier linear units (ReLUs), each ReLU using a set of parameters to apply the function to the input of the ReLU; and
using the softmax layer to predict a value for the informational category for the ingested job listing, based on output of the plurality of ReLUs.

13. A method comprising:
obtaining a training set of one or more job listings having a value of an informational category, the one or more job listings directly input into an online network via a user interface;
for each of the one or more job listings in the training set:
obtaining a plurality of sparse features from the corresponding job listing;
passing a first portion of the plurality of sparse features into an encoding layer of a neural network to convert the first portion of the plurality of sparse features into a first vector;
passing a second portion of the plurality of sparse features into an embedding layer of the neural network to embed the second portion of the plurality of sparse features into an embedding vector;
concatenating the first vector and the embedding vector into a concatenated vector, in a concatenated dense layer of the neural network;
passing the concatenated vector serially through a plurality of rectifier linear units (ReLUs), each ReLU using a set of parameters to apply a function to the input of the ReLU; and
using a softmax layer to predict a value for the informational category for the corresponding job listing, based on output of the plurality of ReLUs.

14. The method of claim 13, further comprising, for each of the one or more job listings in the training set:
determining if a loss function applied to the predicted value and to the value for the informational category has been minimized; and
in response to a determination that the loss function has not been minimized, changing values for the set of parameters and repeating the obtaining a plurality of sparse features, passing a first portion, passing a second portion, concatenating the first vector and the embedding vector to a concatenated vector, passing the concatenated vector, and using a softmax layer.

15. The method of claim 13, wherein the first portion of the plurality of sparse features comprises one or more of: job company, job title, and job location.

16. The method of claim 13, wherein the informational category is workplace type.

17. The method of claim 16, wherein possible values for the workplace type include on-site, remote, and hybrid.

18. The method of claim 13, further comprising:
obtaining an ingested job listing by retrieving the ingested job listing from a third-party data source, the ingested job listing lacking a value of the informational category; and
predicting a value of the informational category for the ingested job listing using the neural network.

19. The method of claim 18, wherein the predicting comprises:
obtaining a plurality of sparse features from the ingested job listing;
passing a first portion of the plurality of sparse features into the encoding layer of the neural network to convert the first portion of the plurality of sparse features into a first vector for the ingested job listing;
passing a second portion of the plurality of sparse features into the embedding layer of the neural network to embed the second portion of the plurality of sparse features into an embedding vector for the ingested job listing;
concatenating the first vector and the embedding vector into a concatenated vector for the ingested job listing, in the concatenated dense layer of the neural network;
passing the concatenated vector serially through the plurality of rectifier linear units (ReLUs), each ReLU using a set of parameters to apply the function to the input of the ReLU; and
using the softmax layer to predict a value for the informational category for the ingested job listing, based on output of the plurality of ReLUs.

20. A system comprising:
means for obtaining a training set of one or more job listings having a value of an informational category, the one or more job listings directly input into an online network via a user interface;
means for, for each of the one or more job listings in the training set:
obtaining a plurality of sparse features from the corresponding job listing;
passing a first portion of the plurality of sparse features into an encoding layer of a neural network to convert the first portion of the plurality of sparse features into a first vector;
passing a second portion of the plurality of sparse features into an embedding layer of the neural network to embed the second portion of the plurality of sparse features into an embedding vector;
concatenating the first vector and the embedding vector into a concatenated vector;
training the neural network using the concatenated vector.
